(19) United States
(12) Patent Application Publication
(10) Pub. No.: US 2009/0177505 A1
(43) Pub. Date: Jul. 9, 2009

(54) Supply and Distribution Method and System Which Considers Environmental or "Green" Practices

(76) Inventors: Brenda L. Dietrich, Yorktown Heights, NY (US); Thomas Robert Ervolina, Poughquag, NY (US); Kaan K. Katircioglu, Yorktown Heights, NY (US); Sharon L. Nunes, Hopewell Junction, NY (US); Peter R. Williams, Danville, CA (US)

Correspondence Address: Whitham, Curtis & Christofferson, P.C., Suite 340, 11491 Sunset Hills Road, Reston, VA, 20190, US

(21) Appl. No.: 11/969,445

(22) Filed: Jan. 4, 2008

(51) Int. Cl. G06Q 10/00; G06F 17/40

(52) U.S. Cl. 705/7

(57) ABSTRACT

The carbon footprint of a supply and distribution chain is modeled as a carbon dioxide (CO₂) cost that can be considered alongside monetary or dollar ($) costs in supply, manufacturing, and distribution operations. Databases on products and services, supply chain policies, and targets, costs, and/or greenhouse gas (GHG) emissions are used by a GHG calculator to output carbon footprint data and/or by a supply chain optimizer to output supply chain planning and policy data. Client computers obtain carbon footprint and/or supply chain planning and policy data by querying a server with access to a database storing calculated carbon footprint data. Input data to the GHG calculator is updated based on choices made by users of the system.

### BACKGROUND OF THE INVENTION

1. Field of the Invention

The present invention generally relates to the organization of supply and distribution operations and, more particularly, to methods and tools for use by businesses and customers to account for and potentially minimize the environmental impact of various options within the supply and distribution chain. Managers within the supply and distribution chain are provided with the data needed to make choices among several options based on monetary costs, delivery time and estimates of environmental impact. On-line commerce sites are able to offer customers a choice of delivery (time and cost) which also incorporates an estimate of environmental impact.

2. Background Description

Typical supply chain optimization evaluates delivery alternatives in terms of direct monetary costs and other traditional performance measures, such as customer service. There is a growing concern about the environmental impact of supply and distribution operations and, in particular, the so-called carbon footprint of such operations. Increasingly, business managers view the reduction of the environmental impact of their operations as good business in terms not only of costs, but also in terms of public relations and customer loyalty. In addition, many on-line commerce sites allow customers to choose delivery methods based on various factors, including, but not limited to, time-to-destination and variable cost. On-line commerce sites do not, however, offer their customers choices based on differences in environmental impact among different delivery method alternatives. Lacking the ability to offer such choices, commerce sites are unable to respond to popular concern over environmental issues by providing information and/or choices on the environmental impact of alternative delivery methods. Since responding to such popular concerns would, among other things, enable on-line commerce sites to increase customer loyalty, there is an unfulfilled need for a solution that takes environmental impact, as well as traditional factors, into account in evaluating and selecting among alternative delivery methods for use in supply and distribution chains and in completing on-line transactions.

### SUMMARY OF THE INVENTION

It is therefore an object of the present invention to provide business managers with the methods and tools to minimize the environmental impact of various options in the supply and distribution chain.

It is another object of the invention expand the choice of delivery methods offered to customers by on-line commerce sites to include an estimate of the environmental impact.

The present invention models so-called carbon footprint as a carbon dioxide (CO₂) cost that can be considered alongside monetary or dollar ($) costs; for example:

| | $ COST | CO₂ COST |
|---|---|---|
| INVENTORY COSTS | | |
| Real estate | X | |
| Utility | X | X |
| Handling | X | X |
| Shrinkage | X | X |
| Breakage | X | X |
| Capital | X | |
| MANUFACTURING COSTS | | |
| Materials | X | X |
| Energy | X | X |
| Other | X | |
| PACKAGING COSTS | | |
| Outside (box) | X | X |
| Inside (Styrofoam) | X | X |
| Inside (Plastic) | X | X |
| Inside (Paperwork/manuals) | X | X |
| TRANSPORTATION COSTS | | |
| Fuel | X | X |
| Other | X | |

Carbon footprints throughout the supply chain may be determined using, for example, activity based costing methodology. Treating the carbon footprint as a cost enables supply chain management decisions which consider both the dollar and the CO₂ costs of operational alternatives. Shipment and package consolidation is one of the major opportunities to reduce carbon footprint. Quantifying the impact of shipment frequency on cost and carbon can help establish a “greener” inventory replenishment policy. Quantifying CO₂ cost as well as dollar cost also makes it possible to identify the minimum-cost-path of getting the product to the customer with maximum carbon reduction potential.

Carbon models can allow sophisticated tradeoffs between carbon and other business variables—cost, waste, time, quality, inventory, service levels, and customer satisfaction. Carbon diagnostic assessment enables initial identification of carbon “hotspots” and carbon management issues. Emissions reporting is on the rise, and businesses are increasingly seeking ways to analyze processes for carbon “hotspots” and, where possible, improve the processes to reduce carbon emissions. Day-to-day management of emission levels and carbon liabilities, along with other aspects of business performance can produce a whole-value-chain assessment if suppliers are included.

Carbon trading has been proposed to create a price for carbon, allowing users of carbon-based energy sources to internalize the environmental cost of carbon emissions. Automatic carbon trading is seen as a longer-term development. Even in the absence of carbon trading programs, however, the present invention could be used to facilitate voluntary action by businesses and consumers to reduce their carbon footprints.

Take, for example, a consumer ordering five items from an on-line commerce site located in California for shipment to New York. The on-line commerce site may typically offer several choices of delivery method, such as shipping items as they are available, shipping all items together, standard ground shipping, express shipping, overnight shipping, and so forth. The present invention enables the site to provide environmental optimization of packaging for shipments (if needed) and to offer its customers information and choices regarding the environmental impact of delivery methods (including, but not limited to, a delivery method's carbon footprint), in addition to existing information and choices such as the time and cost for delivery. Customers would thus be clearly shown the environmental impact of their shipping choices as part of the on-line commerce site's “check-out” procedure. Environmental impact could be calculated real-time, incorporating distance, packaging, overall transportation costs, and overall environmental footprints.

The present invention thus provides a system and method for measuring and monitoring a supply chain's emissions of Green House Gases (GHG) based on operations that cause GHG emissions. A “supply chain” comprises organizations and departments within a firm, the firm's affiliates, and other firms that are in buyer-seller relationships with the firm. GHG comprise one or more of water vapor, carbon dioxide, methane, chlorofluorocarbons (CFCs), and/or hydrochlorofluorocarbons (HCFCs). An “operation” comprises one or more of transportation, manufacturing, inventory holding and warehousing, office operations, and/or information technology (IT) system operations.

The present invention enables managers and e-commerce users to make an intentional choice of a combination of cost and delivery methods to minimize environmental impact of shipped items by, among other things: providing businesses a system to measure and monitor the carbon footprint of their operations and products, and services; giving businesses an ability to reduce their carbon emissions in the best possible way in their supply chain activities; enabling businesses to execute carbon management policies throughout their supply chain operations; helping businesses maximize their revenue from trading in carbon exchanges; and helping businesses to maximize their after tax profit in case of possible a carbon tax.

The system and method of the present invention measures and monitors GHG using:
(a) A computer database system that keeps records sufficient to identify products or services and their associated materials, activities and resources needed to produce the products or services. Such materials, activities and resources may be identified in a bill of materials, bill of activities, and/or bill of resources.
(b) A computer database system that keeps records of GHG emission data for the associated materials, activities and resources, such as for each unit of component in the bill of materials, for each unit of activity in the bill of activities, and for each resource unit in the bill of resources.
(c) A GHG calculator using the data in database systems mentioned in (a) and (b), above, to calculate GHG emission for each product and each service produced, for each material and each resource used, and for each activity performed.
(d) A computer database system keeping the results of GHG calculator.
(e) A computer server-client system wherein the server computer reports data in the database mentioned in (d), above, to client computers.

The system and method of the present invention may also be used to manage GHG in supply chain management processes using an optimization engine that solves one of more of the following:
Minimizing GHG footprint subject to a budget constraint on one or more of supply chain operations.
Minimizing cost of one of more of supply chain operations subject to a GHG footprint target.
Minimizing the sum of the one or more of supply chain operations cost and the GHG cost. (GHG cost may optionally be determined according to the price of GHG on a trading exchange or other market mechanism that allows buying and selling of GHG.)
Minimizing the sum of the one or more of supply chain operations cost and the GHG cost subject to one or more performance targets. (Performance targets may optionally comprise one or more of: probability of on time delivery to customer request; inventory turns; average delay in shipment; and/or probability of shipment delay not exceeding a target amount of time.)

Such optimization may be directed to transportation, storage, or manufacturing. The system and method of the present invention may thus use a computer database system to keep the results produced by an optimization engine and may optionally process, without limitation, one or more of:
Demand planning and execution
Supply planning and execution
Manufacturing planning and execution
Supply network planning and execution
Inventory planning and execution
Transportation planning and execution
Material requirements planning and execution
Distribution requirements planning and execution
Procurement planning and execution
Order fulfillment planning and execution.

Using the present invention, on-line commerce sites may optimize packages for shipping and provide customers with information on the environmental impact of the various forms of transportation that may be used to deliver goods to consumers. On-line commerce sites may thus be enabled to offer customers a delivery choice, not only in terms of time and cost but also in terms of estimated of environmental impact.

The present invention thus provides a method, a system, and/or a machine-readable medium with data processing instructions for
(1) (a) using a computer as a greenhouse gas (GHG) calculator to determine carbon footprint data by processing (i) GHG emission data comprising data on at least one of type of material, type of activity, and type of resource and (ii) product and service data comprising data on at least one of name, attribute, bill of materials, bill of activities, bill of resources, production planning, sales, costs, and performance metrics, and (b) storing and updating the carbon footprint data in a database, the data being organized by product, service, activity, resource, product attribute, service attribute, customer, and/or operation; and

(2) using a server to receive requests for carbon footprint data from client computers and to respond to such requests with data obtained by querying the database containing said carbon footprint data.

In addition, the method, system, and/or machine readable-medium of the present invention may further
(1) (a) use the computer, discussed above, as a supply chain optimizer to run processes directed to the planning and execution of procurement, material requirements, supply, inventory, demand, distribution, transportation, manufacturing, supply network, and/or order fulfillment (i) to determine planning and execution policy data by processing (α) GHG emission data comprising data on at least one of type of material, type of activity, and type of resource, (β) product and service data comprising data on at least one of name, attribute, bill of materials, bill of activities, bill of resources, production planning, sales, costs, and performance metrics, (γ) supply chain policy and target data comprising data on at least one of carbon emissions metrics, budget metrics, customer service metrics, other performance metrics, business rules, and/or business policies and (δ) cost data comprising cost data by at least one of material, activity, and resource, and (ii) to send such planning and execution policy data to a database; and
(2) use the server, discussed above, to receive requests for data on planning and execution policy from client computers and to respond to such requests with data obtained by querying the database containing said planning and execution policy data.

The cost data for the cost database, the products and services database, and/or any other database or purpose may be dollar cost data and/or carbon dioxide cost data.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a block diagram showing supply chain cost comprised of both carbon dioxide cost components and dollar cost components;

FIG. 2 is a data flow diagram showing a manufacturing and distribution operations model being used to capture carbon and cost impact of key levers;

FIG. 3 is a flow diagram illustrating the interaction of factors that drive supply chain carbon footprint;

FIG. 4 is a block diagram showing management of a CO₂ Cycle within a supply and distribution chain;

FIG. 5 is a block diagram of a system that measures and monitors green house gases in supply chain operations of a supply chain; and

FIG. 6 is a block diagram showing in more detail the system that manages and/or optimizes GHG emissions in supply chain operations.

FIG. 7 shows an example of how service level agreement targets can make an impact on carbon footprint.

FIG. 8 shows an example of how package size reduction in combination with routing and sourcing policies impacts the carbon footprint of customer order shipments.

FIG. 9 shows an example of how service level agreement targets in combination with routing and sourcing policies can impact the carbon footprint of customer order shipments.

### DETAILED DESCRIPTION OF A PREFERRED EMBODIMENT OF THE INVENTION

In the preferred embodiment of the present invention, various key factors impact the supply chain cost and carbon footprint through complex multiple interactions. Typical supply chain optimization only considers the direct monetary costs. However, inventory and supply policies can be significantly changed by the inclusion of broader environmental costs and constraints. A model according to the present invention can quantify both the cost and the carbon impact of various supply chain policies, as well as identifying where carbon and cost reduction can be achieved simultaneously (e.g., minimization of wastage, rework, and so forth).

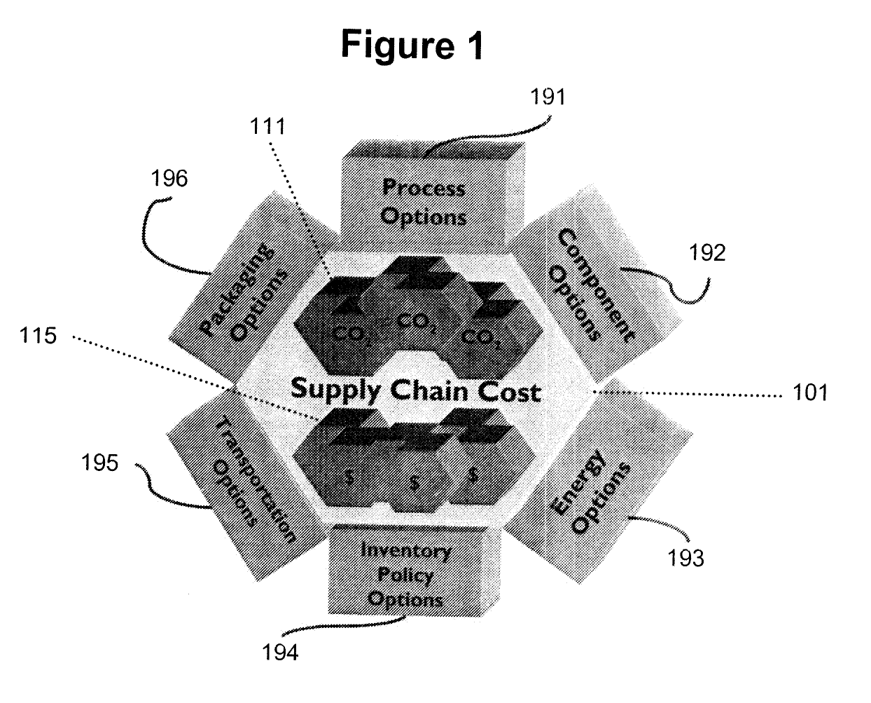

Turning now to the drawings, and especially to FIG. 1, there is shown Supply Chain Cost 101 comprised of both carbon dioxide components 111 and dollar components 115. Supply Chain Cost 101 is also shown as affected by various options, including Process Options 191, Component Options 192, Energy Options 193, Inventory Policy Options 194, Transportation Options 195, and Packaging Options 196.

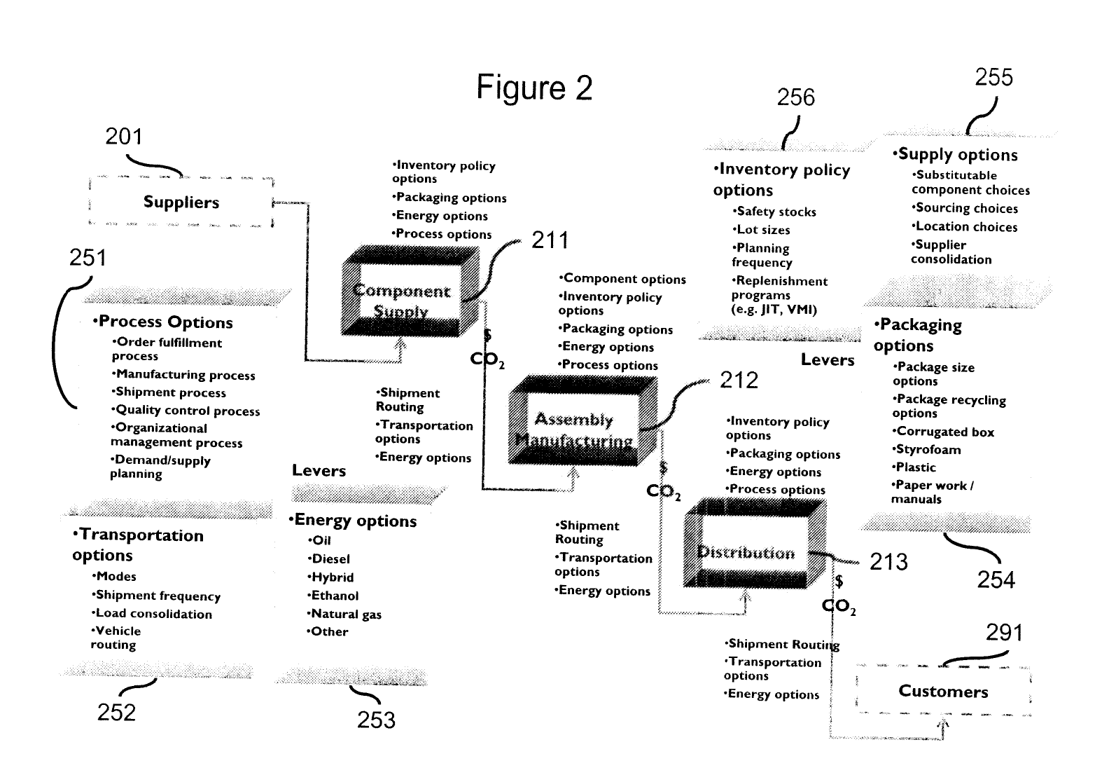

FIG. 2 shows a manufacturing and distribution operations model used to capture carbon and cost impact of key levers. Some levers such as better routing can create a win-win case for both reducing both dollar cost and CO₂ cost in the supply chain. Supplier choice, for example, can impact component cost, carbon emission, and inventory all of which can be quantified to support a green procurement strategy. Quantifying the cost and carbon impact of alternative supply sourcing plans can help in the “greening” decisions.

The main chain of this model runs diagonally from upper left to lower right of the diagram. The chain begins with Suppliers 201 who provide input to Component Supply 211, which includes options such as inventory policy options, packaging options, energy options, and process options. The output of Component Supply 211 serves as input in terms of dollar and CO₂ cost to Assembly/Manufacturing 212, which includes options such as component options, inventory policy options, packaging options, energy options, and process options. The output of Assembly/Manufacturing 212 serves as input in terms of dollar and CO₂ cost for Distribution 213, which again includes options such as inventory policy options, packaging options, energy options, and process options. The output of Assembly/Manufacturing 212 is provided in terms of dollar and CO₂ cost to Customers 291.

As mentioned, levers include, but are not limited to, Process Options 251, Transportation Options 252, Energy Options 253, Packaging Options 254, Supply Options 255, and Inventory Policy Options 256 and may affect the determination of dollar and CO₂ cost as outputted from one or more of Component Supply 211, Assembly/Manufacturing 212, and/or Distribution 213. Process Options 251 include, but are not limited to, order fulfillment process, manufacturing process, shipment process, quality control process, organizational manufacturing process, and demand/supply planning. Transportation Options 252 include, but are not limited to, modes of transportation, shipment frequency, load consolidation, and vehicle routing. Energy Options 253 include, but are not limited to, oil, diesel, hybrid systems, ethanol, natural gas, hydrogen, and other fuels. Packaging Options 254 include, but are not limited to, package size options, package recycling options, corrugated box, Styrofoam, plastic, and paper/work materials. Supply options 255 include, but are not limited to, substitutable component choices, sourcing choices, location choices, and supplier consolidation. Inventory Policy Options 256 include, but are not limited to, safety stocks, lot sizes, planning frequency, and replenishment programs (e.g., JIT, VMI).

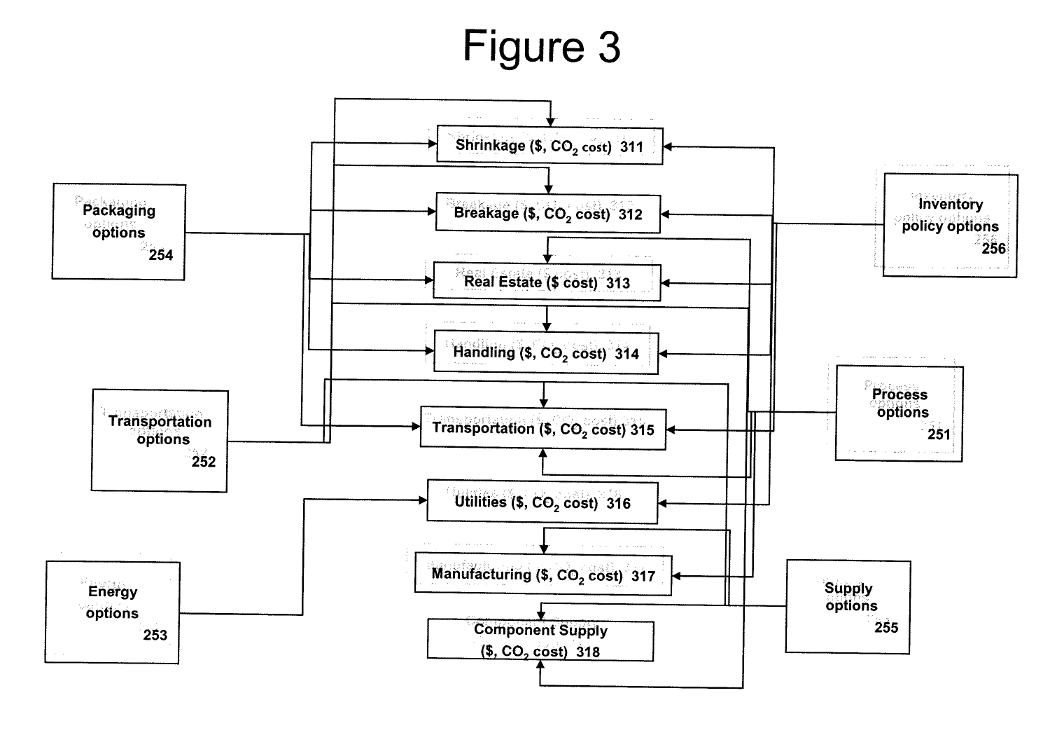

FIG. 3 further shows the interaction of factors that drive supply chain carbon footprint. Process Options 251 may affect dollar and/or CO₂ costs associated with Shrinkage 311, Breakage 312, Real Estate 313, Handling 314, Transportation 315, Utilities 316, Manufacturing 317, and/or Component Supply 318. Transportation Options 252 may affect dollar and/or CO₂ costs associated with Shrinkage 311, Breakage 312, Handling 314, and/or Transportation 315. Energy Options 253 may affect dollar and/or CO₂ costs associated with Utilities 316. Packaging Options 254 may affect Shrinkage 311, Breakage 312, Real Estate 313, Handling 314, and/or Transportation 315. Supply Options 255 may affect dollar and/or CO₂ costs associated with Transportation 315, Manufacturing 317, and/or Component Supply 318. Inventory Policy Options 256 may affect dollar and/or CO₂ costs associated with Shrinkage 311, Breakage 312, Real Estate 313, Handling 314 Transportation 315, Utilities 316, Manufacturing 317, and/or Component Supply 318.

From the foregoing model, it is clear that there are many variables which impact the carbon footprint in the supply chain, and these variables may interact with one another to either increase or decrease the carbon footprint, depending on the choices made. The present invention provides a systematic approach to the analysis of this carbon footprint.

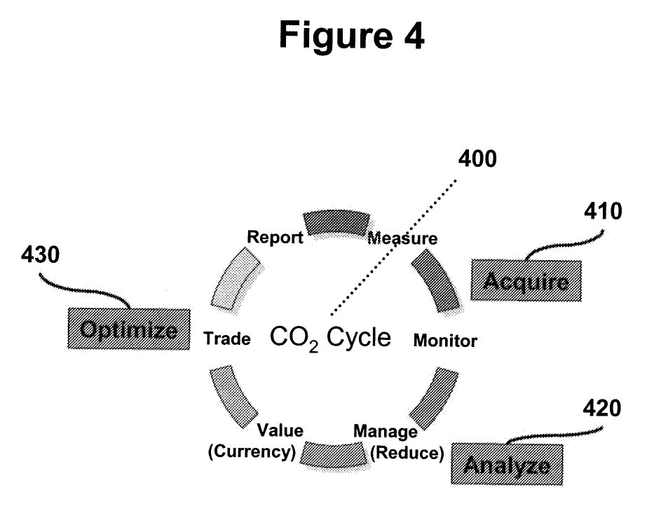

FIG. 4 shows the management of a CO₂ Cycle 400 within a supply and distribution chain through the steps of Acquire data 410, Analyze data 420, and Optimize the process 430. This is a circular process in which data is constantly being updated and analyzed to provide the optimum output to provide business managers and customers choices. The Acquire data 410 step involves measuring input data and monitoring measured data. The Analyze data 420 step manages the acquired data by first reducing the data and then generating a value (currency) of the reduced data. The Optimize 430 step considers the possibility of trading CO₂ emissions and generating a report. The report is the source of the input data which is again measured by the Acquire 410 step.

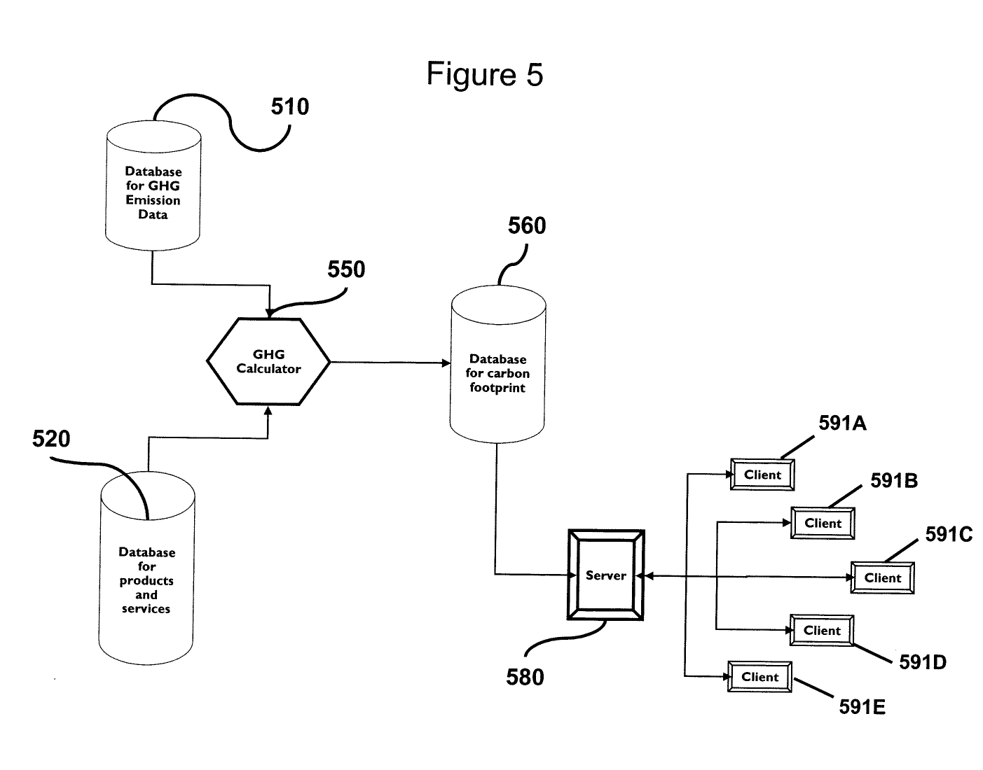

FIG. 5 illustrates in block diagram form the system according to the invention that measures and monitors green house gases (GHG) in supply chain operations. A GHG Calculator 550 computer receives input from a Database for GHG Emission Data 510 and a Database for Products and Services 520 and, after data processing operations are performed on such input to determine carbon footprint data, sends such carbon footprint data as output to Database for Carbon Footprint 560. A Server 580 receives requests for carbon footprint data from Client computers 591A, 591B, 591C, 591D, and/or 591E and calls for responsive data from Database for Carbon Footprint Database 560, which provides the requested data to Server 580, which in turn provides the requested data to Client computers 591A, 591B, 591C, 591D, and/or 591E. The Client computers 591A, 591B, 591C, 591D, and 591E may be a combination of client computers at different stages of the supply and distribution chain and client computers serving as on-line communication interfaces for customers. The client computers at different stages in the supply and distribution chain may be used to provide managers at different points along the supply and distribution chain with the several options, as described in more detail in FIGS. 2 and 3. These options are used by the respective client computers to query the Server 580 which, in turn, accesses the Database 560 to retrieve the stored environmental costs of the various options presented to the managers. The managers, given the costs (both monetary and time) and environmental impact of the several options, can make informed business decisions which take into account the environmental impact of the several options available. This is part of the Optimize 430 step shown in FIG. 4. The output of this step is a report and data that recirculated in the management of the CO₂ cycle. Other client computers serve as the on-line communication interfaces for the customers of the business. These computers generate for a particular transaction the various options for delivery of a product or products to customers, and those options are used to request data from the server concerning not only monetary costs and delivery times of the various options, but also the environmental impact of those options. That data when retrieved from the server 580 is then provided to the customers so that they can make their choices based, at least in part, on the environmental impact of the choices.

The Database for GHG Emission Data 510 may contain, among other things, data on material, activities, and/or resources. The Database for Products and Services 520 may contain, among other things, data on names, attributes, bills of materials, bills of activities, production plans, sales, costs, and/or performance metrics of products and services. Both of these databases are updated based on the output of the Optimize 430 step shown in FIG. 4. The Database for Carbon Footprint 560 may provide carbon footprint data by product or service, by activity, by resource, by product or service attributes, by customer, and/or by customer attributes, among other ways such data may be provided.

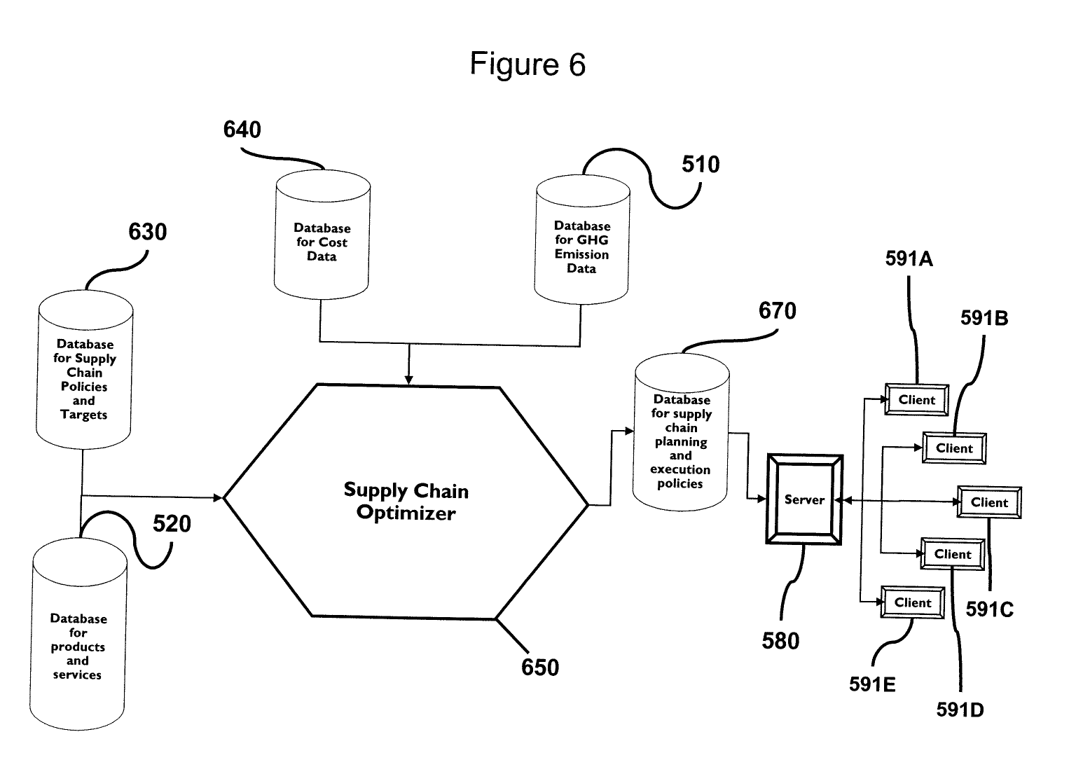

FIG. 6 illustrates in block diagram form in more detail the system that manages and/or optimizes GHG emissions in supply chain operations according to the present invention. This system enables a user to minimize (i) GHG footprint subject to a budget constraint on one or more of supply chain operations, (ii) the cost of one of more of supply chain operations subject to a GHG footprint target, (iii) the sum of the one or more of supply chain operations cost and the GHG cost, and (iv) the sum of the one or more of supply chain operations cost and the GHG cost subject to one or more performance targets. A Supply Chain Optimizer 650 computer receives input from a Database for GHG Emission Data 510, a Database for Products and Services 520, a Database for Supply Chain Policies and Targets 630, and a Database for Cost Data 640. After data processing operations are performed on the input from databases 510, 520, 630, and/or 640, to determine supply chain planning and execution policy data, the Supply Chain Optimizer sends the supply chain planning and execution policy data as output to Database for Supply Chain Planning and Execution Policies 670. The Server 580 receives requests for supply chain planning and execution policy data from Client computers 591A, 591B, 591C, 591D, and/or 591E and calls for responsive data from Database for Supply Chain Planning and Execution Policies Database 670, which provides the requested data to Server 580, which in turn provides the requested data to Client computers 591A, 591B, 591C, 591D, and/or 591E. The Database for GHG Emission Data 510 may contain, among other things, data on material, activities, and/or resources. The Database for Products and Services 520 may contain, among other things, data on names, attributes, bills of materials, bills of activities, production plans, sales, costs, and/or performance metrics of products and services. The Database for Supply Chain Policies and Targets 630 may contain, among other things, data on carbon emissions targets, budgets, customer service targets, other performance targets, business rules, and/or business policies. The Database for Cost Data 640 may contain, among other things, cost data on materials, activities, and/or resources. The Supply Chain Optimizer 650 may run processes directed to, among other things, the planning and execution of, procurement, material requirements, supply, inventory, demand, distribution, transportation, manufacturing, supply network, and/or order fulfillment. The Database for Supply Chain Planning and Execution Policies 670 may provide policy data by product or service, by activity, by resource, by product or service attributes, by customer, and/or by operation, among other ways such data may be provided.

### EXAMPLES

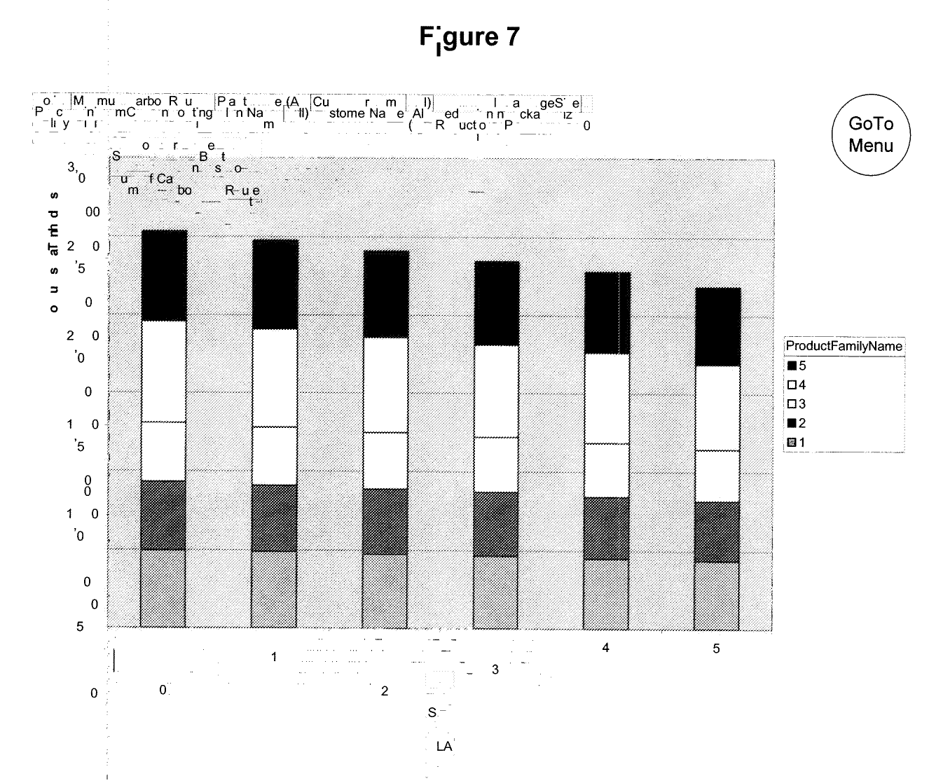

FIG. 7 shows, for product families 1 through 5, how service level agreement (SLA) targets (X-axis) make an impact on carbon footprint (Y-axis). SLA targets are shown in terms of a different bar graph for each different scenario, with scenarios labeled by number of additional days. FIG. 7 shows an implementation using four policy options, as shown (different options and a different number of options could be used). Thus, for example, if two additional days are allowed for shipment of customer orders, then carbon emissions can be reduced down to around 2,300 thousand tons from a bit above 2,500 thousand tons. The choices above the chart provide the ability to customize the chart for a plant, and a customer. There are two more options displayed in the chart: package size reduction options and policy options. Reducing package size reduces volume and weight of the package and hence the cost and carbon of transporting the products. Various policy options can be used, including, without limitation, minimum carbon routing (each order shipped to minimize its transportation carbon footprint), minimum cost routing (each order shipped to minimize its transportation cost), minimum carbon sourcing (each order shipped from a source selected to provide minimum transportation carbon footprint), and minimum cost sourcing (each order shipped from a source selected to provide minimum transportation cost). Thus, carbon footprint and cost may be considered.

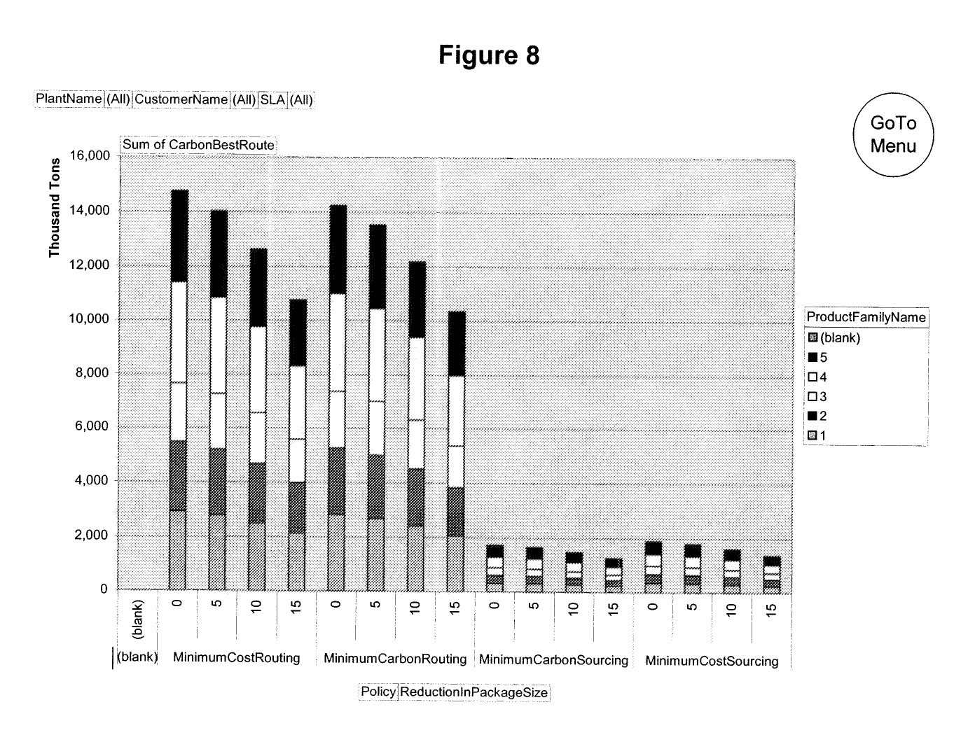

FIG. 8, shows, for product families 1 through 5 (with an unused slot available for a product family 6), how package size reduction in combination with routing and sourcing policies (X-axis) impacts the carbon footprint of customer order shipments (Y-axis). The choices above the chart provide the ability to customize the chart for a plant, and a customer. Reducing package size reduces volume and weight of the package and hence the cost and carbon of transporting the products. Thus, for example, if a policy of minimum carbon routing is followed, and package size is reduced by 10%, then total carbon footprint is around 12,000 thousand tons.

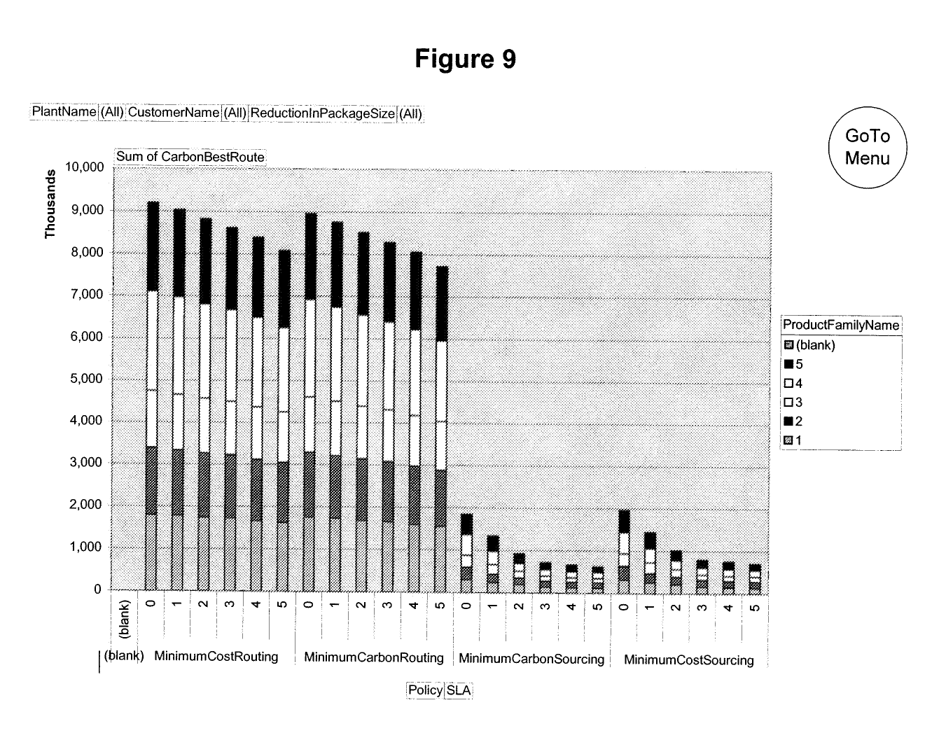

FIG. 9 shows for product families 1 through 5 (with an unused slot available for a product family 6), how SLA targets in combination with routing and sourcing policies (X-axis) impact the carbon footprint of customer order shipments (Y-axis). The choices above the chart provide the ability to customize the chart for a plant, and a customer. Thus, for example, if a policy of minimum carbon sourcing is followed, and customers allow two more days for shipment (i.e., SLA=2), then the total carbon footprint of all order shipments can be reduced to a bit under 1,000 thousand tons.

While the invention has been described in terms of a single preferred embodiment, those skilled in the art will recognize that the invention can be practiced with modification within the spirit and scope of the appended claims.

Having thus described our invention, what we claim as new and desire to secure by Letters Patent is as follows:

1. A computer implemented method to manage options in a supply and distribution chain for the purpose of minimizing the environmental impact of various options in the supply and distribution chain based on an estimate of environmental impact, comprising the steps of:
calculating carbon footprint data in a supply and distribution chain by processing green house gas (GHG) emission data for various options within the supply and distribution chain;
storing the calculated carbon footprint data in a database;
generating by one or more client computers various options for a product or products in a particular point in the supply and distribution chain;
requesting by said one or more client computers using the generated options data from a server data from the server concerning not only monetary costs and delivery times of the various options, but also the environmental impact of those options;
accessing the database by the server in response to requests from said one or more client computers to retrieve the carbon footprint data for each of the various options; and
providing by said one or more client computers data retrieved from the server to users of said one or more client computers so that users can make choices based, at least in part, on the environmental impact of the choices.

2. The computer implemented method of claim 1, further comprising the steps of:
receiving choices made by users of said one or more client computers and generating outputs, including reports and output data for the supply and distribution chain;
measuring the output data to generate updated data; and
using said updated data to calculate the carbon footprint data in a supply and distribution chain.

3. The computer implemented method of claim 1, wherein some of said at least one or more client computers provides managers at different points along the supply and distribution chain with several options, further comprising the steps of:
receiving choices made by managers and generating outputs, including reports and output data for the supply and distribution chain;
measuring the output data to generate updated data; and
using said updated data to calculate the carbon footprint data in a supply and distribution chain.

4. The computer implemented method of claim 1, wherein at least one of said least one or more client computers provides a customer interface for an on-line transaction, further comprising the steps of:
displaying data to a customer of delivery options and their costs, including environmental impact of the delivery options, for a particular transaction; and
receiving a choice of delivery option made by the customer.

5. The computer implemented method of claim 1, wherein the data for various options within the supply and distribution chain are selected from process options, transportation options, energy options, inventory policy options, supply options, and packaging options.

6. A system for supplying products to customers which accounts for a carbon dioxide impact imposed by the supply and distribution of one or more products to one or more customers in a supply and distribution chain, comprising:
a greenhouse gas (GHG) calculator which calculates a carbon footprint due to GHG emission data for various options within the supply and distribution chain;
at least one database for storing the carbon footprint data calculated by the GHG calculator;
one or more client computers which generate various options for a product or products in a particular point in the supply and distribution chain, said one or more client computers generating queries concerning not only monetary costs and delivery times of various options, but also the environmental impact of the various options; and
a server connected to said at least one database and to said one or more client computers, said server responding to queries from said one or more client computers to access data in said at least one database to provide requested data to said one or more client computers.

7. The system of claim 6, wherein choices made by users of said one or more client computers are used to generate outputs, including reports and output data for the supply and distribution chain, the output data being measured to updated data, and said updated data being used by said GHG calculator to calculate the carbon footprint data in a supply and distribution chain.

8. The system of claim 6, wherein some of said at least one or more client computers provide managers at different points along the supply and distribution chain with several options, the client computers receiving choices made by managers and generating outputs, including reports and output data for the supply and distribution chain, the output data being measured to generate updated data, and the updated data being used by the GHG calculator to calculate the carbon footprint data in a supply and distribution chain.

9. The system of claim 6, wherein at least one of said least one or more client computers provides a customer interface for an on-line transaction, the client computers displaying data to a customer delivery options and their costs, including environmental impact of the delivery options, for a particular transaction and receiving a choice of delivery option made by the customer.

10. The system of claim 1, wherein the data for various options within the supply and distribution chain are selected from process options, transportation options, energy options, inventory policy options, supply options, and packaging options.

11. A computer readable medium containing code for implementing a method to manage options in a supply and distribution chain for the purpose of minimizing the environmental impact of various options in the supply and distribution chain based on an estimate of environmental impact, said method comprising the steps of:
calculating carbon footprint data in a supply and distribution chain by processing green house gas (GHG) emission data for various options within the supply and distribution chain;
storing the calculated carbon footprint data in a database;
generating by one or more client computers various options for a product or products in a particular point in the supply and distribution chain;
requesting by said one or more client computers using the generated options data from a server data from the server concerning not only monetary costs and delivery times of the various options, but also the environmental impact of those options;
accessing the database by the server in response to requests from said one or more client computers to retrieve the carbon footprint data for each of the various options; and
providing by said one or more client computers data retrieved from the server to users of said one or more client computers so that users can make choices based, at least in part, on the environmental impact of the choices.

12. The computer readable medium of claim 10, wherein the code further implements the steps of:
receiving choices made by users of said one or more client computers and generating outputs, including reports and output data for the supply and distribution chain;
measuring the output data to generate updated data; and
using said updated data to calculate the carbon footprint data in a supply and distribution chain.
